(19) United States
(12) Patent Application Publication
(10) Pub. No.: US 2008/0255258 A1
(43) Pub. Date: Oct. 16, 2008

(54) Method For the Production of Monodispersed Pearl Polymers Containing Acrylic

(76) Inventors: Wolfgang Podszun, Munchen (DE); Pierre Vanhoorne, Monheim (DE); Dmitry Chernyshov, Wuppertal (DE)

Correspondence Address: Nicanor A. Kohncke;LANXESS Law & Intellectual Property Department, 111 RIDC Park West Drive, Pittsburgh, PA, 15275-1112, US

(21) Appl. No.: 10/588,337

(22) PCT Filed: Jan. 25, 2005
(86) PCT No.: PCT/EP05/00670

§ 371 Date: May 10, 2007

(30) Foreign Application Priority Data
Feb. 6, 2004 (DE) 10 2004 006 115.7

(51) Int. Cl. B01J 39/20

(52) U.S. Cl. 521/38

(57) ABSTRACT

The present invention relates to a method for the production of monodisperse acrylic-containing bead polymers, preferably having a particle size of 5 to 500 μm, and also to their functionalization to give ion exchangers.

The invention relates to a method for the production of monodisperse acrylic-containing ion exchangers, the intermediates necessary for this which are termed monodisperse acrylic-containing bead polymers and which preferably have a particle size of 5 to 500 μm, and also the use of the monodisperse acrylic-containing ion exchangers.

Weakly acidic cation exchangers are generally obtained by hydrolysis of crosslinked acrylic bead polymers. For instance, crosslinked polymethyl acrylate or polyacrylonitrile bead polymers are converted into carboxylate-containing beads by reaction with sulfuric acid or sodium hydroxide solution. On the basis of crosslinked acrylic bead polymers, likewise weakly basic anion exchangers can be obtained by reaction of the acrylate groups with diamines. By alkylation of these weakly basic anion exchangers, strongly basic anion exchangers can be produced.

Recently, ion exchangers having a particle size as uniform as possible (hereinafter termed “monodisperse”) have increasingly been gaining importance, because in many applications, owing to the more favorable hydrodynamic properties of an exchanger bed of monodisperse ion exchangers, economic advantages can be achieved. Monodisperse ion exchangers can be obtained by functionalization of monodisperse bead polymers. One of the possibilities of producing monodisperse bead polymers is what is termed the seed/feed method, according to which a monodisperse polymer (“seed”) is swollen in the monomer and this is then polymerized. Seed/feed methods are described, for example, in EP-00 98 130 B1 and EP 0 101 943 B1.

EP-A 0 826 704 discloses a seed-feed method in which microencapsulated crosslinked bead polymer is used as seed.

A problem of the known methods for the production of monodisperse ion exchangers by seed-feed technique is the provision of monodisperse seeds. A frequently employed method is fractionating bead polymers by customary, i.e. broad, particle size distribution. A disadvantage of this method is that with increasing monodispersity the yield of the desired target fraction in the sieving greatly decreases.

By atomization techniques, monodisperse bead polymers may be produced in a targeted manner. Atomization methods suitable for ion exchangers are described, for example, in EP 0 046 535 B1 and EP 0 051 210 B1. A shared characteristic of these atomization methods is their very high technical complexity. The atomization methods generally lead to ion exchangers having a particle size of 500 to 1200 μm. Ion exchangers having smaller particle sizes cannot be produced, or can be produced only with significantly increased expenditure.

EP-A 0 448 391 discloses a method for the production of polymer particles of uniform particle size in the range from 1 to 50 μm. In this method an emulsion polymer having particle sizes of preferably 0.05 to 0.5 μm is used as seed. The small diameter of the seed particles used is unfavorable, because many repetitions of the feed steps are necessary.

EP-A 0 288 006 discloses crosslinked monodisperse bead polymers having a particle size of 1 to 30 μm. These bead polymers are obtained by a seed-feed method in which seed particles are used.

Although numerous methods and processes for the production of monodisperse bead polymers or monodisperse ion exchangers have been previously described, all known methods are virtually completely based on styrene-containing bead polymers.

In Chemistry of Materials 1998, Vol. 10, pages 385-291, Fréchet et al. describe the production of crosslinked monodisperse acrylic-containing bead polymers having a diameter of up to 5 μm, based on noncrosslinked monodisperse seed polymers.

DE-A 102 37601, in contrast, discloses monodisperse gel-type ion exchangers having a diameter of up to 500 μm, where as feed, a monomer mixture of a seed polymer is added which contains 50 to 99.9% by weight styrene and, as comonomers, copolymerizable compounds such as, e.g., methyl methacrylate, ethyl methacrylate, ethyl acrylate, hydroxyethyl methacrylate or acrylonitrile.

Narrow-distribution acrylic-containing bead polymers or narrow-distribution weakly acidic cation exchangers in the range 30 to 500 μm are customarily obtained by fractionation of bead polymers or weakly acidic cation exchangers having a broad particle size distribution. A disadvantage of this method is that with increasing monodispersity, the yield of the desired target fraction in the fractionation greatly decreases.

Previously, no method exists for the targeted production of monodisperse acrylic-containing ion exchangers from monodisperse acrylic-containing bead polymers having a particle size of 5 to 500 μm.

The object of the present application was therefore to provide a method for the targeted production of monodisperse acrylic-containing ion exchangers.

The present invention relates to a method for the production of monodisperse acrylic-containing ion exchangers, characterized in that
a) a noncrosslinked monodisperse seed polymer having a particle size of 0.5 to 20 μm is produced by free-radical-initiated polymerization of monoethylenically unsaturated compounds in the presence of a nonaqueous solvent,
b) to a nonaqueous dispersion of the seed polymer in the presence of a dispersant a monomer feed is added which contains
   0.1 to 2% by weight of initiator,
   1 to 60% by weight of crosslinker and
   30 to 98.9% by weight of acrylic monomer, of which up to 49.9% by weight can be replaced by styrene,
   the monomer feed is allowed to swell into the seed and at elevated temperature is polymerized to give crosslinked monodisperse acrylic-containing bead polymers, preferably having a particle size of 5 to 500 μm, and
c) these crosslinked monodisperse acrylic-containing bead polymers are converted by functionalization into monodisperse acrylic-containing ion exchangers.

In an embodiment of the present invention, in method step a′), to an aqueous dispersion of the seed polymer from method step a) in the presence of a dispersant, at least one monomer feed can be added which contains

0.1 to 5% by weight of initiator and

95 to 99.9% by weight of monoethylenically unsaturated compounds but no crosslinker, this monomer feed is allowed to swell into the seed and polymerized at elevated temperature to give noncrosslinked monodisperse seed polymers. Method step a′) can be repeated once to several times, before the method is continued with method step b). By this measure, noncrosslinked seed polymers of any particle size in the range from 1 to 300 μm may be obtained.

The present invention relates not only to the monodisperse acrylic-containing ion exchangers as claimed in method step c), but also to the intermediates obtainable by method step b), the crosslinked monodisperse acrylic-containing bead polymers.

Several times in the context of the present invention means addition of the monomer feed up to ten times, preferably up to eight times, particularly preferably up to six times.

After method step b), the monodisperse acrylic-containing bead polymers have a particle size of 5 to 500 μm, preferably 10 to 400 μm, particularly preferably 20 to 300 μm, very particularly preferably 51 to 300 μm. For determination of the mean particle size and the particle size distribution, customary methods such as sieving analysis or image analysis are suitable. As a measure of the width of the particle size distribution of the inventive monodisperse acrylic-containing ion exchangers, the ratio of the 90% value (Ø (90)) and the 10% value (Ø (10)) of the volume distribution is formed. The 90% value (Ø (90)) gives the diameter which is greater than 90% of the particles. Correspondingly, 10% of the particles are smaller than the diameter of the 10% value (Ø (10)). Monodisperse particle size distributions in the context of the invention mean Ø (90)/Ø (10)≦1.5, preferably Ø (90)/Ø (10)≦1.25.

For production of the noncrosslinked seed polymer as claimed in method step a), use is made of monoethylenically unsaturated compounds, no polyethylenically unsaturated compounds or crosslinkers being used.

According to the invention, suitable monoethylenic compounds are: styrene, vinyltoluene, α-methylstyrene, chlorostyrene, esters of acrylic acid and methacrylic acid such as methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, and isobornyl methacrylate. Preference is given to styrene, methyl acrylate and butyl acrylate. Mixtures of different monoethylenically unsaturated compounds are also highly suitable.

In the production of the noncrosslinked seed polymer, the abovementioned monoethylenically unsaturated compound(s) are polymerized in the presence of a nonaqueous solvent with use of an initiator. Suitable solvents according to the invention are dioxane, acetone, acetonitrile, dimethylformamide and alcohols. Preference is given to alcohols, in particular methanol, ethanol, n-propanol, isopropanol, n-butanol, isobutanol and tert-butanol. Mixtures of various solvents are also very suitable, in particular mixtures of various alcohols. The alcohols can also contain up to 50% by weight of water, preferably up to 25% by weight of water. When solvent mixtures are used, nonpolar solvents, in particular hydrocarbons, such as hexane, heptane and toluene, can be used in conjunction in fractions up to 50% by weight.

The ratio of monoethylenically unsaturated compounds to solvent is 1:2 to 1:30, preferably 1:3 to 1:15.

The seed polymer as claimed in method step a) is preferably prepared in the presence of a high-molecular-weight dispersant dissolved in the solvent.

Suitable high-molecular-weight dispersants are natural and synthetic macromolecular compounds. Examples are cellulose derivatives, such as methylcellulose, ethylcellulose, hydroxypropylcellulose, polyvinyl acetate, partially saponified polyvinyl acetate, polyvinylpyrrolidone, copolymers of vinylpyrrolidone and vinyl acetate, and also copolymers of styrene and maleic anhydride. Polyvinylpyrrolidone is preferred. The content of high-molecular-weight dispersant is 0.1 to 20% by weight, preferably 0.2 to 10% by weight, based on the solvent.

In addition to the dispersants, use can also be made of ionic or nonionic surfactants. Suitable surfactants in the context of the present invention are, e.g., sulfosuccinic acid sodium salt, methyltricaprylammonium chloride or ethoxylated nonylphenols. Preference is given to ethoxylated nonylphenols having 4 to 20 ethylene oxide units. The surfactants can be used in amounts of 0.1 to 2% by weight, based on the solvent.

Suitable initiators for preparing the seed polymer to be produced as claimed in method step a) are compounds which form free radicals on temperature elevation. Those which may be mentioned by way of example are: peroxy compounds such as dibenzoyl peroxide, dilauryl peroxide, bis(p-chlorobenzoyl) peroxide, dicyclohexyl peroxydicarbonate and tert-amylperoxy-2-ethylhexane, in addition azo compounds such as 2,2′-azobis(isobutyronitrile) or 2,2′-azobis(2-methylisobutyronitrile). If the solvent contains a water fraction, sodium or potassium peroxydisulfate is also suitable as initiator.

Very suitable compounds are also aliphatic peroxy esters. Examples of these are tert-butyl peroxyacetate, tert-butyl peroxyisobutyrate, tert-butyl peroxypivalate, tert-butyl peroxyoctoate, tert-butyl peroxy-2-ethylhexanoate, tert-butyl peroxyneodecanoate, tert-amyl peroxypivalate, tert-amyl peroxyoctoate, tert-amylperoxy-2-ethylhexanoate, tert-amyl peroxyneodecanoate, 2,5-bis(2-ethylhexanoylperoxy)-2,5-dimethylhexane, 2,5-dipivaloyl-2,5-dimethylhexane, 2,5-bis(2-neodecanoylperoxy)-2,5-dimethylhexane, di-tert-butyl peroxyazelate or di-tert-amyl peroxyazelate.

The initiators are generally used in amounts of 0.05 to 6.0% by weight, preferably 0.2 to 5.0% by weight, particularly preferably 1 to 4% by weight, based on the sum of the monoethylenically unsaturated compounds.

If appropriate, inhibitors soluble in the solvent can be used. Examples of suitable inhibitors are phenolic compounds such as hydroquinone, hydroquinone monomethyl ether, resorcinol, catechol, tert-butylcatechol, condensation products of phenols with aldehydes. Further organic inhibitors are nitrogen compounds such as, e.g., diethylhydroxylamine or isopropylhydroxylamine. According to the invention, resorcinol is preferred as inhibitor. The concentration of the inhibitor is 0.01 to 5% by weight, preferably 0.1 to 2% by weight, based on the sum of the monoethylenically unsaturated compounds.

The polymerization temperature is directed by the decomposition temperature of the initiator, and also by the boiling temperature of the solvent, and is typically in the range from 50 to 150° C., preferably 60 to 120° C. It is advantageous to polymerize at the boiling temperature of the solvent, with constant stirring, for example using a gate agitator. Low stirring speeds are used. With 4-liter laboratory reactors, the stirring speed of a gate agitator is 100 to 250 rpm, preferably 100 rpm.

The polymerization time is generally a plurality of hours, e.g. 2 to 30 hours.

The seed polymers produced according to the invention as claimed in method step a) are highly monodisperse and have particle sizes of 0.5 to 20 μm, preferably 2.2 to 15 μm. The particle size may be affected, inter alia, by the choice of solvent. For instance, higher alcohols, such as n-propanol, isopropanol, n-butanol, isobutanol and tert-butanol, deliver larger particles than methanol. A fraction of water or hexane in the solvent can shift the particle size towards lower values. Addition of toluene increases the particle size.

The seed polymer can be isolated by conventional methods, such as sedimentation, centrifugation or filtration. To separate off the dispersant, the mixture is washed with alcohol and/or water and dried.

The monoethylenically unsaturated compounds to be used in method step a′) are: styrene, vinyltoluene, a-methylstyrene, chlorostyrene, esters of acrylic acid and methacrylic acid such as methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, and isobornyl methacrylate. Preference is given to styrene, methyl acrylate and butyl acrylate. Mixtures of different monoethylenically unsaturated compounds are also highly suitable. In a preferred embodiment of method step a′), the fraction of acrylic monomer is increased on each repetition. For the definition of the acrylic monomer, reference may be made to method step b).

As initiators which are obligatorily used in the monomer feed of method step a′), the free-radical formers described under method step a) come into consideration. The initiators are generally used in amounts of 0.1 to 5.0% by weight, preferably 0.5 to 3% by weight, based on the monomer feed. Of course, mixtures of the abovementioned free-radical formers can also be used, for example mixtures of initiators having a differing decomposition temperature.

The weight ratio of seed polymer to monomer feed of method step a′) is 1:1 to 1:1000, preferably 1:2 to 1:100, particularly preferably 1:3 to 1:30.

The addition of the monomer feed to the seed polymer of method step a) or of an upstream method step a′) generally proceeds in such a manner that, to an aqueous dispersion of the seed polymer, a finely divided aqueous emulsion of the monomer feed is added. Finely divided emulsions having mean particle sizes of 1 to 10 μm are highly suitable, which can be produced using rotor-stator mixers, or mixer-jet nozzles using emulsifying aids, such as, e.g., isooctyl sulfosuccinate sodium salt.

The constituents of the monomer feed as claimed in method step a′) can be added together or else individually to the seed polymer, the individual constituents being added in each step in the form of a finely divided emulsion as described above. The composition of the sum of all added organic phases (monomer feed) is critical for the present invention. It can be advantageous, in the case of metering in a plurality of metering steps, to add the total amount of initiator in the first metering step.

The monomer feed in method step a′) can be added at temperatures below the decomposition temperature of the initiator, for example at room temperature. It is advantageous to meter in the monomer feed-containing emulsion(s) with stirring in the course of a relatively long period, e.g. in the course of 0.25 to 5 hours. After complete addition of the emulsion(s), the mixture is further stirred, the monomer feed penetrating into the seed particles. A further stirring time of 1 to 15 hours is expedient. The amounts of water used in production of the seed polymer suspension and monomer mixture emulsion are not critical within broad limits. Generally, 5 to 50% strength suspensions or emulsions are used.

The resultant mixture of seed polymer, monomer feed and water is also admixed in method step a′) with at least one dispersant, with natural and synthetic water-soluble polymers being suitable such as, e.g., gelatin, starch, polyvinyl alcohol, polyvinylpyrrolidone, polyacrylic acid, polymethacrylic acid or copolymers of (meth)acrylic acid or (meth)acrylic acid esters. Cellulose derivatives are also very highly suitable, in particular cellulose esters or cellulose ethers, such as carboxymethyl cellulose or hydroxyethylcellulose. The amount of dispersant used is generally 0.05 to 1%, preferably 0.1 to 0.5%, based on the water phase.

The water phase of method step a′) can, in addition, contain a buffer system which sets the pH of the water phase to a value between 12 and 3, preferably between 10 and 4. Particularly highly suitable buffer systems contain phosphate, acetate, citrate or borate salts.

It can also be advantageous in method step a′) to use an inhibitor dissolved in the aqueous phase. Inhibitors which come into consideration are not only inorganic but also organic substances. Examples of inorganic inhibitors are nitrogen compounds such as hydroxylamine, hydrazine, sodium nitrite or potassium nitrite. Examples of organic inhibitors are phenolic compounds such as hydroquinone, hydroquinone monomethyl ether, resorcinol, catechol, tert-butylcatechol or condensation products of phenols with aldehydes. Further organic inhibitors are nitrogen compounds such as, e.g., diethylhydroxylamine or isopropylhydroxylamine. Resorcinol is preferred as inhibitor according to the invention. The concentration of the inhibitor is 5 to 1000 ppm, preferably 10 to 500 ppm, particularly preferably 20 to 250 ppm, based on the aqueous phase.

Elevated temperature for method step a′) in the context of the present invention is taken to mean by a person skilled in the art a temperature elevation up to the decomposition temperature of the initiator, generally 60 to 130° C. This initiates the polymerization of the monomer feed swollen into the seed particles. The polymerization lasts for a plurality of hours, e.g. 3 to 10 hours.

In a further embodiment of the present invention, the monomer feed is added over a relatively long period of 1 to 6 hours at a temperature at which at least one of the initiators used is active. Generally, in this procedure, temperatures of 60 to 130° C., preferably 60 to 95° C., are employed.

By means of the severalfold repetition of the feed steps, i.e. addition of monomer feed, swelling and polymerization, ultimately, from monodisperse seed polymers having particle sizes of 0.5 to 20 μm, noncrosslinked monodisperse seed polymers having particle sizes of up to 300 μm are accessible.

After the polymerization, the monodisperse noncrosslinked seed bead polymer from method step a′) can be isolated by customary methods, e.g. by filtration or decantation, and, if appropriate, after single or repeated washing, dried and if desired sieved and stored.

In method step b), the seed polymer from a) or a′) having a feed of an acrylic monomer is admixed with initiator and crosslinker.

According to the invention the monomer feed of method step b) contains 30 to 98.9% by weight of acrylic monomer, preferably 50 to 97.9% by weight of acrylic monomer. Acrylic monomers in the context of this invention are esters of acrylic acid and methacrylic acid such as, e.g., methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, isobornyl methacrylate, N,N′-dimethylaminoethyl acrylate, N,N′-dimethylaminoethyl methacrylate, glycidyl acrylate and glycidyl methacrylate, in addition acrylonitrile, methacrylonitrile, acrylamide or methacrylamide. Preference is given to acrylonitrile, acrylamide, methyl acrylate, methyl methacrylate, butyl acrylate and glycidyl methacrylate. Mixtures of different acrylic monomers are also highly suitable.

In a particularly preferred variant of the present invention, no styrene is present in the monomer feed of method step b). However, the monomer feed of method step b) can if appropriate contain further comonomers. Suitable comonomers are compounds which are copolymerizable with acrylic monomers, such as, e.g., α-methylstyrene, ethyl vinyl ether, methyl vinyl ether, tert-butyl vinyl ether, N-vinylpyrrolidones, N-vinylpyridines, 2-vinylpyridines and 4-vinylpyridines. The amount of comonomers is 0 to 68.9% by weight, preferably 0 to 48.9% by weight, in each case based on the added activated monomer feed.

According to the invention the monomer feed of method step b) contains 1 to 60% by weight of crosslinker, based on the activated monomer feed added. Crosslinkers are compounds having two or more polymerizable olefinic double bonds in the molecule. Those which may be mentioned by way of example are divinylbenzene, allyl methacrylate, ethylene glycol dimethacrylate, butanediol dimethacrylate, trimethylolpropane triacrylate, butanediol divinyl ether, diethylene glycol divinyl ether or octadiene. Divinylbenzene, octadiene or diethylene glycol divinyl ether are preferred. The divinylbenzene can be used in commercially available quality which, in addition to the isomers of divinylbenzene, also contains ethylvinyl benzenes.

The amount of crosslinker in the monomer feed of method step b) is preferably 2 to 30% by weight, particularly preferably 3 to 18% by weight, in each case based on the activated monomer feed added.

Initiators to be used obligatorily in the monomer feed of method step b) which come into consideration are the free-radical formers described under method step a). The initiators are generally employed in amounts of 0.1 to 2.0% by weight, preferably 0.5 to 2% by weight, based on the monomer feed. Of course, mixtures of the abovementioned free-radical formers can also be used, for example mixtures of initiators having a differing decomposition temperature.

The weight ratio of seed polymer to monomer feed in method step b) is 1:1 to 1:1000, preferably 1:2 to 1:100, particularly preferably 1:3 to 1:30.

Addition of the monomer feed in method step b) to the seed polymer from a) or a′) generally proceeds in such a manner that a finely divided aqueous emulsion of the monomer feed is added to an aqueous dispersion of the seed polymer. Highly suitable emulsions are finely divided emulsions having mean particle sizes of 1 to 10 μm which can be produced using rotor-stator mixers or mixing-jet nozzles using emulsifying aids, such as, e.g., isooctyl sulfosuccinate sodium salt.

The constituents of the monomer feed in method step b) can be added to the seed polymer from a) or a′) together or else individually, the individual constituents being added in each step in the form of a finely divided emulsion as described above. The composition of the sum of all added organic phases (monomer feed) is critical for the present invention. It can be advantageous, in the case of metering in a plurality of metering steps, to add the total amount of initiator in the first metering step.

Addition of the monomer feed in method step b) can proceed at temperatures below the decomposition temperature of the initiator, for example at room temperature. It is advantageous to add the emulsion(s) containing the monomer feed with stirring in the course of a relatively long time period, e.g. in the course of 0.25 to 5 hours. After complete addition of the emulsion(s) the mixture is further stirred, the monomer feed penetrating into the seed particles. A further stirring time of 1 to 15 hours is expedient. The amounts of water used in the production of the seed polymer suspension and monomer mixture emulsion are not critical within broad limits. Generally, 5 to 50% strength suspensions or emulsions are used.

The resultant mixture of seed polymer, monomer feed and water in method step b) is admixed with at least one dispersion aid, natural and synthetic water-soluble polymers such as, e.g., gelatin, starch, polyvinyl alcohol, polyvinylpyrrolidone, polyacrylic acid, polymethacrylic acid or copolymers of (meth)acrylic acid or (meth)acrylic acid esters being suitable. Very highly suitable compounds are also cellulose derivatives, in particular cellulose esters or cellulose ethers, such as carboxymethylcellulose or hydroxyethylcellulose. The amount of the dispersion aid used in method step b) is generally 0.05 to 1%, preferably 0.1 to 0.5%, based on the water phase.

The water phase of method step b) can, in addition, contain a buffer system which sets the pH of the water phase to a value between 12 and 3, preferably between 10 and 4. Particularly highly suitable buffer systems contain phosphate, acetate, citrate or borate salts.

It can be advantageous in method step b) to use an inhibitor dissolved in the aqueous phase. Inhibitors which come into consideration in method step b) are not only inorganic, but also organic substances. Examples of inorganic inhibitors are nitrogen compounds, such as hydroxylamine, hydrazine, sodium nitrite or potassium nitrite. Examples of organic inhibitors are phenolic compounds such as hydroquinone, hydroquinone monomethyl ether, resorcinol, catechol, tert-butylcatechol or condensation products of phenols with aldehydes. Further organic inhibitors are nitrogen compounds such as, e.g., diethylhydroxylamine or isopropylhydroxylamine. Resorcinol is preferred according to the invention as inhibitor. The concentration of the inhibitor is 5 to 1000 pm, preferably 10 to 500 ppm, particularly preferably 20 to 250 ppm, based on the aqueous phase.

Elevated temperature for method step b) is taken by those skilled in the art to mean a temperature elevation to the decomposition temperature of the initiator, generally 60 to 130° C. By this means the polymerization of the monomer feed swollen into the seed particles is introduced. The polymerization lasts for a plurality of hours, e.g. 3 to 10 hours.

In a further embodiment of the present invention, the addition of the monomer feed in method step b) proceeds over a relatively long time period from 1 to 6 hours at a temperature at which at least one of the initiators used is active. Generally, in this procedure, temperatures of 60 to 130° C. are employed, preferably 60 to 95° C.

By means of method step b), from monodisperse seed polymers of method steps a) or a′), monodisperse acrylic-containing bead polymers preferably having particle sizes of up to 500 μm are accessible. The enlargement factor results here from the polymerization conversion rate and the weight ratio of seed polymer from a) or a′) to the monomer feed of method step b).

After the polymerization, the monodisperse acrylic-containing bead polymer from method step b) can be isolated by customary methods, e.g. by filtration or decantation, and if appropriate dried after single or repeated washing and if desired sieved and stored.

In method step c), the monodisperse acrylic-containing bead polymers are used as starting material for the production of monodisperse ion exchangers. The reaction of the bead polymers to give ion exchangers can proceed according to known methods. For instance, weakly acidic cation exchangers are produced by hydrolysis of the monodisperse acrylic-containing bead polymers from method step b). Suitable hydrolysis agents are strong bases or strong acids such as, e.g., sodium hydroxide solution or sulfuric acid.

After the hydrolysis, the reaction mixture of hydrolysis product and residual hydrolysis agent is cooled to room temperature and first diluted with water and washed.

When sodium hydroxide solution is used as hydrolysis agent, the weakly acidic cation exchanger is produced in the sodium form. For some applications it is expedient to convert the cation exchanger from the sodium form into the acidic form. This change is performed using sulfuric acid of a concentration of 5 to 50%, preferably 10 to 20%.

If desired, the inventive resultant weakly acidic cation exchanger, for purification, can be treated with deionized water at temperatures of 70 to 145° C., preferably from 105 to 130° C.

Weakly basic anion exchangers can be produced, for example, by reacting the monodisperse acrylic-containing bead polymers produced by the inventive method from method step b) with an aminoalcohol or a bifunctional amine. A preferred aminoalcohol is N,N′-dimethyl-2-aminoethanol. A preferred difunctional amine is (N,N′-dimethyl)-3-aminopropylamine (“amine Z”).

From the weakly basic anion exchangers, strongly basic anion exchangers can be produced by known methods by quaternization with alkylating agents such as, e.g., methyl chloride.

The monodisperse acrylic-containing ion exchangers obtained by the inventive method are distinguished by a high monodispersity and particularly high stability and are likewise subject matter of the present invention like the monodisperse acrylic-containing bead polymers according to method step b).

The present invention therefore also relates to monodisperse acrylic-containing ion exchangers obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
b) adding a monomer feed to an aqueous dispersion of the seed polymer from method step a) in the presence of a dispersant, the monomer feed containing
   0.1 to 2% by weight of initiator,
   1 to 60% by weight of crosslinker and
   30 to 98.9% by weight of acrylic monomer, of which up to 49.9% by weight can be replaced by styrene,
   swelling the monomer feed into the seed and polymerizing at elevated temperature to give crosslinked monodisperse acrylic-containing bead polymers, preferably having a particle size of 5 to 500 μm, and
c) functionalizing these crosslinked monodisperse acrylic-containing bead polymers.

The present invention, however, also relates to monodisperse acrylic-containing ion exchangers obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
a′) adding at least one monomer feed to an aqueous dispersion of the seed polymer from method step a) in the presence of a dispersant, this monomer feed containing 0.1 to 5% by weight of initiator and 95 to 99.9% by weight of monoethylenically unsaturated compounds, allowing the monomer feed to swell into the seed and polymerizing to give a noncrosslinked monodisperse seed polymer at elevated temperature,
b) adding a monomer feed to an aqueous dispersion of the seed polymer from method step a′) in the presence of a dispersant, the monomer feed containing
   0.1 to 2% by weight of initiator,
   1 to 60% by weight of crosslinker and
   30 to 98.9% by weight of acrylic monomer, of which up to 49.9% by weight can be replaced by styrene,

swelling the monomer feed into the seed and polymerizing at elevated temperature to give crosslinked monodisperse acrylic-containing bead polymers preferably crosslinked monodisperse acrylic-containing bead polymers having a particle size of 5 to 500 μm, and
c) functionalizing these crosslinked monodisperse acrylic-containing bead polymers.

However, the present invention also relates to the monodisperse acrylic-containing bead polymer preferably having a particle size of 5 to 500 μm obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
b) adding at least one monomer feed to an aqueous dispersion of the seed polymer in the presence of a dispersant, which contains
   0.1 to 2% by weight of initiator,
   1 to 60% by weight of crosslinker and
   30 to 98.9% by weight of acrylic monomer, of which up to 49.9% by weight can be replaced by styrene,
   swelling the monomer feed into the seed and polymerizing at elevated temperature.

The present invention also relates to monodisperse acrylic-containing bead polymers preferably having a particle size of 5 to 500 μm, obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
a′) adding at least one monomer feed to an aqueous dispersion of the seed polymer from method step a) in the presence of a dispersant, this monomer feed containing 0.1 to 5% by weight of initiator and 95 to 99.9% by weight of monoethylenically unsaturated compounds, allowing the monomer feed to swell into the seed and polymerizing to give a noncrosslinked monodisperse seed polymer at elevated temperature,
b) adding a monomer feed to an aqueous dispersion of the seed polymer from method step a′) in the presence of a dispersant, which contains
   0.1 to 2% by weight of initiator,
   1 to 60% by weight of crosslinker and
   30 to 98.9% by weight of acrylic monomer, of which up to 49.9% by weight can be replaced by styrene,
   swelling the monomer feed into the seed and polymerizing at elevated temperature.

The monodisperse acrylic anion exchangers produced according to the invention are used
for removing anions from aqueous or organic solutions and their vapors
for removing color particles from aqueous or organic solutions and their vapors,
for decolorizing and desalting glucose solutions, wheys, low-viscosity gelatin broths, fruit juices, fruit musts and sugars, preferably mono- or disaccharides, in particular cane sugar, beet sugar solutions, fructose solutions, for example in the sugar industry, dairies, starch industry and in the pharmaceutical industry,
for removing organic components from aqueous solutions, for example humic acids from surface water,
for separating off and purifying biologically active components such as, for example, antibiotics, enzymes, peptides and nucleic acids from their solutions, for example from reaction mixtures and from fermentation broths,
for analysis of the ion content of aqueous solutions by ion-exchange chromatography.

The present invention therefore also relates to
methods for removing anions from aqueous organic solutions and their vapors, or color particles from aqueous or organic solutions and their vapors, using the inventive monodisperse acrylic-containing anion exchangers.
methods for decolorizing and desalting glucose solutions, wheys, low-viscosity gelatin broths, fruit juices, fruit musts and sugars, preferably mono- or disaccharides, in particular cane sugar, beet sugar solutions, fructose solutions, for example in the sugar industry, dairies, starch industry and the pharmaceutical industry, using inventive monodisperse acrylic-containing anion exchangers.
methods for removing organic components from aqueous solutions, for example humic acids from surface water, using the inventive monodisperse acrylic-containing anion exchangers.
methods for separating off and purifying biologically active components such as, for example, antibiotics, enzymes, peptides and nucleic acids from their solutions, for example from reaction mixtures and from fermentation broths, using the inventive monodisperse acrylic-containing anion exchangers.
methods for analysis of the ion content of aqueous solutions by ion-exchange chromatography, using the inventive monodisperse acrylic-containing anion exchangers.

In addition, the inventive monodisperse acrylic-containing anion exchangers can be used for the purification and workup of waters in the chemical industry and electronics industry.

In addition, the inventive monodisperse acrylic-containing anion exchangers can be used in combination with gel-type and/or macroporous cation exchangers for demineralization of aqueous solutions, in particular in the sugar industry.

The monodisperse acrylic-containing cation exchangers produced according to the invention are used in differing applications. For instance, they are also used, for example, in drinking water treatment and for the chromatographic separation of glucose and fructose.

The present invention therefore relates to the use of the inventive monodisperse acrylic-containing cation exchangers
for removing cations, color particles or organic components from aqueous or organic solutions,
for softening in neutral exchange of aqueous or organic solutions,
for purification and workup of waters of the chemical industry, the electronics industry and from power stations,
for separating off and purifying biologically active components such as, for example, antibiotics, enzymes, peptides and nucleic acids from their solutions, for example from reaction mixtures and from fermentation broths,
for analysis of the ion content of aqueous solutions by ion-exchange chromatography.

The present invention therefore also relates to
methods for the purification and workup of waters of the chemical industry, the electronics industry and from power stations, characterized in that use is made of the inventive monodisperse acrylic-containing cation exchangers.
methods for removing cations, color particles or organic components from aqueous or organic solutions, characterized in that use is made of the inventive monodisperse acrylic-containing cation exchangers.
methods for softening in the neutral exchange of aqueous or organic solutions, characterized in that use is made of the inventive monodisperse acrylic-containing cation exchangers.
methods for separating off and purifying biologically active components such as, for example, antibiotics, enzymes, peptides and nucleic acids from their solutions, for example from reaction mixtures and from fermentation broths, characterized in that use is made of the inventive monodisperse acrylic-containing cation exchangers.
methods for the analysis of the ion content of aqueous solutions by ion-exhcnage chromatography, characterized in that use is made of the inventive monodisperse acrylic-containing cation exchangers.

The monodisperse acrylic-containing bead polymers produced according to the invention as claimed in method step b) can also be used in a variety of applications, such as, e.g., for separating off and purifying biologically active components from their solutions, for removing color particles or organic components from aqueous or organic solutions, and as supports for organic molecules such as chelating agents, enzymes and antibodies.

The present invention therefore relates to the use of the inventive monodisperse acrylic-containing bead polymers from method step b)
for separating off and purifying biologically active components such as, for example, antibiotics, enzymes, peptides and nucleic acids from their solutions, for example from reaction mixtures and from fermentation broths,
for removing color particles or organic components from aqueous or organic solutions,
as supports for organic molecules such as chelating agents, enzymes and antibodies which are either adsorbed to the support or are covalently or ionically fixed by reaction with a functional group present on the support.

The present invention therefore also relates to
methods for separating off and purifying biologically active components such as, for example, antibiotics, enzymes, peptides and nucleic acids from their solutions, for example from reaction mixtures and from fermentation broths, characterized in that the inventive monodisperse acrylic-containing bead polymers are used according to method step b),
methods for removing color particles or organic components from aqueous or organic solutions, characterized in that the inventive monodisperse acrylic-containing bead polymers are used according to method step b),
methods for binding organic molecules such as chelating agents, enzymes and antibodies to a support, characterized in that the inventive monodisperse acrylic-containing bead polymers are used as support according to method step b).

### EXAMPLES

### Example 1

1a) Production of seed polymer 1

2681.14 g of methanol, 205.71 g of polyvinylpyrrolidone K 30 from Aldrich, 6.86 g of ethyl methacrylate and 336.00 g of methyl methacrylate are charged into a 4 liter flat-flange vessel having a gate agitator, cooler, temperature sensor and also thermostat and temperature recorder. The initial charge stirred at 100 rpm is heated under nitrogen in the course of 1 hour to 55° C. Then, a solution consisting of 10.29 g of 2,2-azobis(isobutyronitrile) and 188.57 g of methanol is added. The monomer mixture is polymerized for 20 hours at 55° C., then cooled to room temperature. This produces a bead polymer having a diameter of 6 μm. The product is sedimented overnight. The supernatent solution is then decanted off. The sediment is washed by taking it up twice in 2 liters of methanol in each case and twice in 2 liters of deionized water in each case, stirred, sedimented and decanted off. Subsequently, an approximately 20% strength aqueous suspension is produced and the solids content determined. This gives a yield of 85.5%.

1b) Production of the acrylic-containing bead polymer 1

332.01 g of the 20.09% strength seed suspension produced in 1a) are homogenized in 801.49 g of deionized water and 16.89 g of 75% strength dioctyl sodium sulfosuccinate with stirring at 150 rpm and nitrogen feed in a 4 liter flat-flange vessel having a gate agitator, cooler, temperature sensor and also thermostat and temperature recorder.

180.0 g of methyl acrylate, 20.0 g of diethylene diglycol divinyl ether and 2.67 g of 75% strength dibenzyl peroxide are emulsified in 100 g of deionized water and 2.0 g of 75% strength dioctyl sodium sulfosuccinate using an Ultraturrax for 1 min at 24 000 rpm. This mixture is flushed into the initial charge using 100 g of deionized water. After a swelling time of 2 hours, this produces beads of 8.6 μm. This corresponds to an efficiency of 63.3%. Then, the mixture is heated in the course of 1 hour to 80° C. and polymerized for 12 hours at 80° C. Then it is cooled to room temperature. The total batch is sedimented overnight, thereafter the supernatent solution is decanted off. The sediment is washed by taking it up 3 times in 2 liters of deionized water, stirred, sedimented and decanted off.

Then an approximately 20% strength suspension is produced and the solids content determined. The yield is 75.8%.

1c) Saponification of the acrylic-containing bead polymer 1

549 g of deionized water together with 366 g of 50% strength NaOH solution are charged in a 4 liter flat-flange vessel having a gate agitator, distillation bridge, temperature sensor and also thermostat and temperature recorder at 200 rpm. With stirring, 150 g of acrylic-containing bead polymer 1 are introduced in portions. The mixture is heated in the course of 1.5 hours to 100° C. Then, it is stirred at this temperature for 6 hours and thereafter cooled to room temperature. The saponified product has a diameter of 12.1 μm. It is made up to 5 liters using deionized water, allowed to stand and decanted off. The entire procedure is repeated until the pH is neutral (in the example 5 times). An approximately 20% strength suspension is produced and the solids content determined. The yield of monodisperse weakly acidic cation exchanger 1 in the sodium form is 99%.

Ion-exchange of the weakly acidic cation exchanger 1

472 g of the 16.95% strength suspension produced in c) are charged into a 4 liter flat-flange vessel having gate agitator, cooler, temperature sensor and also thermostat and temperature recorder. At 200 rpm, 274.67 g of 14.56% strength sulfuric acid solution (6% with respect to the entire water phase) are added dropwise in the course of 6 hours. The suspension is stirred overnight for approximately 15 hours. The ion-exchanged product has a diameter of 10 μm. It is sedimented and decanted off. Then it is washed with deionized water. Make up to 2 liters, sediment and decant off. The entire procedure is repeated until the pH is neutral (in the example 6 times). An approximately 20% strength suspension is produced and the solids content is determined. The yield is 63.2 g.

### Example 2

2a) Production of seed polymer 2

2400 g of n-butanol and 180 g of polyvinylpyrrolidone (Luviskol® K30) were stirred for 60 min in a 4 liter three-neck flask, a homogeneous solution being obtained. The reactor was then flushed with a nitrogen stream of 20 l/h and 300 g of styrene were added in the course of a few minutes with further stirring at 150 rpm. The reactor was heated to 80° C.

When a temperature of 71° C. was reached, a solution of 3 g of azodiisobutyric acid and 117 g of n-butanol heated to 40° C. was added all at once. The stirring speed was increased to 300 rpm for 2 min. After return to 150 rpm, the nitrogen stream was shut off. The reaction mixture was kept at 80° C. for 20 h. Thereafter, the reaction mixture was cooled to room temperature, the resultant polymer was isolated by centrifugation, washed twice with methanol and twice with water. This produced in this manner 2970 g of an aqueous dispersion of seed polymer 2 having a solids content of 10% by weight. The particle size was 2.9 μm, Ø (90)/Ø (10) was 1.29.

2a′-1) Production of seed polymer 2′-1

In a plastic vessel, a finely divided emulsion-I was produced from 300 g of styrene, 9.24 g of 75% strength by weight dibenzoyl peroxide, 500 g of water, 3.62 g of ethoxylated nonylphenol (Arkopal®) N060), 0.52 g of isooctyl sulfosuccinate sodium salt and 2 g of 3,3′,3″,5,5′, 5″-hexa-tert-butyl-alpha, alpha′, alpha″-(mesitylene-2,4,6-triyl)tri-p-cresol (Irganox® 1330 inhibitor) using an Ultraturrax (3 min at 13 500 rpm). A solution of 5 g of methylhydroxyethylcellulose in 2245 g of deionized water and 404 g of aqueous dispersion from 2a) was charged into a 4 liter three-neck flask which was flushed with a nitrogen stream of 20 l/h. At room temperature, with stirring, the finely divided emulsion-I was pumped in at a constant rate in the course of 3 hours. The batch was then left at room temperature for a further 13 hours and then heated to 80° C. for 9 hours. Thereafter, the reaction mixture was cooled to room temperature, the resultant polymer was isolated by centrifugation, washed twice with methanol and twice with water and dispersed in water. This produced, in this manner, 1300 g of an aqueous dispersion of seed polymer 2′-1 having a solids content of 22.6% by weight. The particle size was 6.6 μm, Ø (90)/Ø (10) was 1.33.

2a′-2) Production of seed polymer 2′-2

Step 2a′-1 was repeated, but the following were used:
an emulsion-II produced in a similar manner to emulsion-I using a mixture of 200 g of styrene and 100 g of methyl acrylate
170 g of the dispersion from 2a′-1)

The resultant bead polymer was washed four times with water and dispersed in water. This produced 1420 g of an aqueous dispersion of seed polymer 2′-2 having a solids content of 9.9% by weight. The particle size was 10.6 μm, Ø (90)/Ø (10) was 1.37.

2a′-3) Production of seed polymer 2′-3

Step 2a′ was repeated, but the following were used:
an emulsion-III produced in a similar manner to emulsion-I using a mixture of 100 g of styrene and 200 g of methyl acrylate and
404 g of the dispersion from 2a′-2),

emulsion-III was kept during production and metering to 0 to 5° C. and the batch, after the end of metering, was left at room temperature for 14 h and heated to 80° C. for 7 h.

The resultant bead polymer was washed four times with water and dispersed in water. This produced 1370 g of an aqueous dispersion of seed polymer 2′-3 having a solids content of 9.1% by weight. The particle size was 21 μm, Ø (90)/Ø (10) was 1.41.

2b) Production of the acrylic-containing bead polymer 2

In a plastic vessel a finely divided emulsion-IV was produced at a temperature between 0 and 5° C. from 285 g of methyl acrylate, 15 g of diethylene glycol divinyl ether, 0.03 g of hydroquinone, 9.24 g of dibenzoyl peroxide, 500 g of water, 3.62 g of ethoxylated nonylphenol (Arkopal® N060), 0.52 g of isooctyl sulfosuccinate sodium salt and 2 g of 3,3′,3″5,5′5″-hexa-tert-butyl-alpha, alpha′, alpha″-(mesitylene-2,4,6-triyl)tri-p-cresol (Irganox® 1330 inhibitor) using an Ultraturrax (3 min. at 10 000 rpm).

A solution of 10 g of methylhydroxyethylcellulose in 2245 g of deionized water, 440 g of aqueous dispersion from 2a′-3) and 460 g of deionized water were charged into a 4 liter three-neck flask which was flushed with a nitrogen stream of 20 l/h. At room temperature, with stirring, the finely divided emulsion-IV kept between 0 and 5° C. was pumped in in the course of 3 hours at constant rate. The batch was then left at room temperature for a further 14 hours and then heated to 80° C. for 5 hours. Thereafter, the reaction mixture was cooled to room temperature, the resultant polymer was isolated by centrifugation, washed twice with methanol and twice with water, and dispersed in water. This produced in this manner 622 g of an aqueous dispersion of the acrylic-containing bead polymer 2 having a solids content of 26.2% by weight. The particle size was 39 μm, Ø (90)/Ø (10) was 1.44.

2c) Hydrolysis to give the weakly acidic cation exchanger 2

681 g of the aqueous dispersion from 2b) were filtered off and charged together with 580 ml of deionized water into a 4 l three-neck flask. The batch was heated to reflux with stirring (100 rpm). Then, in the course of 2 h, 256 g of a 50% strength sodium hydroxide solution were added, thereafter 1280 g in the course of 75 min. The batch was held at reflux by suitable elevation of the temperature. The reaction time was 7 h in total. After the end of metering, 230 ml of water were distilled off. The final temperature was 120° C. Thereafter, the reaction mixture was cooled to room temperature, the viscous dispersion diluted with 5 liters of water and the cation-exchange beads were copiously washed with water on a sieve. The resultant cation exchanger in the sodium form was converted to the H form using 3 liters of 6% strength sulfuric acid and washed to neutrality on a sieve using deionized water. After filtration on a vacuum filter, this produced 660 g of finely divided weakly acidic, water-moist cation-exchange beads in the H form. The solids content was 23%, the particle size was 50 μm, Ø (90)/Ø (10) was 1.29. The content of weakly acidic groups was 2.12 mmol per ml of moist resin.

### Example 3

Starting from the aqueous dispersion from 2a′-3), the following procedure was followed:

3b) Production of the acrylic-containing bead polymer 3

In a plastic vessel, a finely divided emulsion-V was produced from 285 g of acrylonitrile, 15 g of diethylene glycol divinyl ether, 9.24 g of dibenzoyl peroxide, 500 g of water, 4.50 g of ethoxylated nonylphenol (Arkopal® N060), 0.80 g of isooctyl sulfosuccinate sodium salt and 6 g of 3,3′,3″5,5′5″-hexa-tert-butyl-alpha, alpha′, alpha″-(mesitylene-2,4,6-triyl)tri-p-cresol (Irganox® 1330 inhibitor) using an Ultraturrax (3 min. at 10 000 rpm).

A solution of 10 g of methylhydroxyethylcellulose in 2245 g of deionized water, 440 g of aqueous dispersion from 2a′-3) and 460 g of deionized water was charged into a 4 liter three-neck flask which was flushed with a nitrogen stream of 20 l/h. At room temperature, the finely divided emulsion-V was pumped in at constant rate with stirring in the course of 3 hours. The batch was then left at room temperature for a further 14 hours and then heated to 80° C. for 6 hours. Thereafter, the reaction mixture was cooled to room temperature, the resultant polymer isolated by centrifugation, washed twice with dimethylformamide and twice with water and dispersed in water. This produced, in this manner, 761 g of an aqueous dispersion of the acrylic-containing bead polymer 3 having a solids content of 12.9% by weight. The particle size was 43 μm, Ø (90)/Ø (10) was 1.38.

3c) Hydrolysis to give the weakly acidic cation exchanger 3

711 g of the dispersion from 3b) were filtered off and charged together with 300 ml of deionized water into a 4 liter three-neck flask. The batch was heated to reflux with stirring (100 rpm). Then, in the course of 2 h, 132 g of a 50% strength sodium hydroxide solution were added, thereafter 638 g in the course of 75 min. The batch was kept at reflux by suitable elevation of the temperature. The reaction time was, in total, 7 h. After the end of metering, 450 ml of water were distilled off. The final temperature was 120° C. Thereafter, the reaction mixture was cooled to room temperature, the viscous light dispersion diluted with 5 liters of water and the cation-exchange beads were washed copiously with water on a sieve. The resultant cation exchanger in the sodium form was converted to the H form using 3 liters of 6% strength sulfuric acid and washed with deionized water to neutrality on a sieve. After filtration on a vacuum filter, this produced 550 g of finely divided weakly acidic water-moist cation-exchange beads in the H form. The solids content was 22%, the particle size was 50 μm, Ø (90)/Ø (10) was 1.42.

1. A method for the production of monodisperse acrylic-containing ion exchangers, characterized in that
a) a noncrosslinked monodisperse seed polymer having a particle size of 0.5 to 20 μm is produced by free-radical-initiated polymerization of monoethylenically unsaturated compounds in the presence of a nonaqueous solvent,
b) to a nonaqueous dispersion of the seed polymer in the presence of a dispersant a monomer feed is added which contains
0.1 to 2% by weight of initiator,
1 to 60% by weight of crosslinker and
30 to 98.9% by weight of acrylic monomer, of which up to 49.9% by weight can be replaced by styrene,
the monomer feed is allowed to swell into the seed and at elevated temperature is polymerized to give crosslinked monodisperse acrylic-containing bead polymers, preferably having a particle size of 5 to 500 μm, and
c) these crosslinked monodisperse acrylic-containing bead polymers are converted by functionalization into monodisperse acrylic-containing ion exchangers.

2. A monodisperse acrylic-containing ion exchanger obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
b) adding a monomer feed to an aqueous dispersion of the seed polymer in the presence of a dispersant, the monomer feed containing
0.1 to 2% by weight of initiator,
1 to 60% by weight of crosslinker and
30 to 98.9% by weight of acrylic monomer, of which up to 49.9% by weight can be replaced by styrene,
swelling the monomer feed into the seed and polymerizing at elevated temperature to give crosslinked monodisperse acrylic-containing bead polymers, preferably having a particle size of 5 to 500 μm, and
c) functionalizing these crosslinked monodisperse acrylic-containing bead polymers.

3. A monodisperse acrylic-containing bead polymer, preferably having a particle size of 5 to 500 μm, obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
b) adding a monomer feed to an aqueous dispersion of the seed polymer from method step a) in the presence of a dispersant, the monomer feed containing
0.1 to 2% by weight of initiator,
1 to 60% by weight of crosslinker and
30 to 98.9% by weight of acrylic monomer, of which up to 49.9% by weight can be replaced by styrene,
swelling the monomer feed into the seed and polymerizing at elevated temperature.

4. A method for the production of monodisperse acrylic-containing ion exchangers, characterized in that
a) a noncrosslinked monodisperse seed polymer having a particle size of 0.5 to 20 μm is produced by free-radical-initiated polymerization of monoethylenically unsaturated compounds in the presence of a nonaqueous solvent,
a′) to an aqueous dispersion of the seed polymer from a), in the presence of a dispersant, at least one monomer feed is added which contains 0.1 to 5% by weight of initiator and 95 to 99.9% by weight of monoethylenically unsaturated compounds but no crosslinker, allowing the monomer feed to swell into the seed and polymerizing,
b) to a nonaqueous dispersion of the seed polymer from method step a′) in the presence of a dispersant a monomer feed is added which contains
0.1 to 2% by weight of initiator,
1 to 60% by weight of crosslinker and
30 to 98.9% by weight of acrylic monomer, of which up to 49.9% by weight can be replaced by styrene,
the monomer feed is allowed to swell into the seed and at elevated temperature is polymerized to give crosslinked monodisperse acrylic-containing bead polymers, preferably having a particle size of 5 to 500 μm, and
c) these crosslinked monodisperse acrylic-containing bead polymers are converted by functionalization into monodisperse acrylic-containing ion exchangers.

5. A monodisperse acrylic-containing ion exchanger obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
a′) adding at least one monomer feed to an aqueous dispersion of the seed polymer from a) in the presence of a dispersant, this monomer feed containing 0.1 to 5% by weight of initiator and 95 to 99.9% by weight of monoethylenically unsaturated compounds but no crosslinker, allowing the monomer feed to swell into the seed and polymerizing to give a crosslinked monodisperse bead polymer at elevated temperature,
b) adding a monomer feed to an aqueous dispersion of the seed polymer from method step a′) in the presence of a dispersant, the monomer feed containing
0.1 to 2% by weight of initiator,
1 to 60% by weight of crosslinker and
30 to 98.9% by weight of acrylic monomer, of which up to 49.9% by weight can be replaced by styrene,
swelling the monomer feed into the seed and polymerizing at elevated temperature to give crosslinked monodisperse acrylic-containing bead polymers, preferably having a particle size of 5 to 500 μm, and
c) functionalizing these crosslinked monodisperse acrylic-containing bead polymers.

6. A monodisperse acrylic-containing bead polymer, preferably having a particle size of 5 to 500 μm, obtainable by
a) producing a noncrosslinked monodisperse seed polymer having a particle size of 0.5 to 20 μm by free-radical-initiated polymerization of monoethylenically unsaturated compounds in the presence of a nonaqueous solvent,
a′) adding at least one monomer feed to an aqueous dispersion of the seed polymer from a) in the presence of a dispersant, the monomer feed containing 0.1 to 5% by weight of initiator and 95 to 99.9% by weight of monoethylenically unsaturated compounds but no crosslinker. Allowing the monomer feed to swell into the seed and polymerizing to give a noncrosslinked bead polymer at elevated temperature.
b) adding a monomer feed to an aqueous dispersion of the seed polymer from method step a′) in the presence of a dispersant, the monomer feed containing
0.1 to 2% by weight of initiator,
1 to 60% by weight of crosslinker and
30 to 98.9% by weight of acrylic monomer, of which up to 49.9% by weight can be replaced by styrene,
swelling the monomer feed into the seed and polymerizing at elevated temperature.

7. The method as claimed in claims 1 or 4, characterized in that the monomer feed in method step b) is added in the form of a finely divided aqueous emulsion.

8. The monodisperse acrylic-containing bead polymer as claimed in claim 6, characterized in that, in method step a), as monoethylenic compound, styrene and in method step a′) at least one monomer feed contains between 20 and 49.9% styrene.

9. A method for the production of monodisperse weakly acidic cation exchangers, characterized in that, in method step c) of claims 1 and 4, the monodisperse acrylic-containing bead polymers from method step b) are hydrolyzed by strong bases or strong acids.

10. A method for the production of anion exchangers, characterized in that the monodisperse, acrylic-containing bead polymers obtained according to method step b) of claims 1 and 4 are reacted in method step c) with diamines or aminoalcohols.

11. The use of the monodisperse acrylic-containing cation exchangers obtainable as claimed in claim 9
for removing cations, color particles or organic components from aqueous or organic solutions,
for softening in neutral exchange of aqueous or organic solutions,
for purification and workup of waters of the chemical industry, the electronics industry and from power stations,
for decolorizing and desalting wheys, low-viscosity gelatin broths, fruit juices, fruit musts and aqueous solutions of sugars,
for separating off and purifying biologically active components such as, for example, antibiotics, enzymes, peptides and nucleic acids from their solutions, for example from reaction mixtures and from fermentation broths,
for analysis of the ion content of aqueous solutions by ion-exchange chromatography.

12. The use of the monodisperse acrylic-containing anion exchangers obtainable as claimed in claim 10
for removing anions from aqueous or organic solutions and their vapors
for removing color particles from aqueous or organic solutions and their vapors,
for decolorizing and desalting glucose solutions, wheys, low-viscosity gelatin broths, fruit juices, fruit musts and sugars, preferably mono- or disaccharides, in particular cane sugar, beet sugar solutions, fructose solutions,
for removing organic components from aqueous solutions, for example humic acids from surface water,
for separating off and purifying biologically active components such as, for example, antibiotics, enzymes, peptides and nucleic acids from their solutions, for example from reaction mixtures and from fermentation broths,
for analysis of the ion content of aqueous solutions by ion-exchange chromatography.

13. The use of the monodisperse, acrylic-containing bead polymers obtainable as claimed in claim 3 or 6
for separating off and purifying biologically active components such as, for example, antibiotics, enzymes, peptides and nucleic acids from their solutions, for example from reaction mixtures and from fermentation broths,
for removing color particles or organic components from aqueous or organic solutions,
as support for organic molecules such as chelating agents, enzymes and antibodies.
